(19) United States
(12) Patent Application Publication
(10) Pub. No.: US 2015/0136305 A1
(43) Pub. Date: May 21, 2015

(54) ROTOR BLADE PRODUCTION DEVICE AND CORRESPONDING METHOD

(71) Applicant: Durr Systems GmbH, Bietigheim-Bissingen (DE)

(72) Inventors: Marc Ullmann, Stuttgart (DE); Lothar Rademacher, Bietigheim-Bissingen (DE); Andreas Reiner, Schulzendorf (DE); Alexander Meissner, Stuttgart (DE)

(21) Appl. No.: 14/397,663

(22) PCT Filed: May 3, 2013
(86) PCT No.: PCT/EP2013/001324

§ 371 Date: Feb. 4, 2015

(30) Foreign Application Priority Data
May 3, 2012 (DE) 10 2012 008 965.1
Nov. 5, 2012 (DE) 10 2012 021 658.0

(51) Int. Cl. B29C 65/00

(52) U.S. Cl. CPC B29C 66/95; B29C 66/72; B29L 2031/085
USPC 156/64; 156/378

(57) ABSTRACT

A device is proved for measuring surfaces of joint locations of at least two joint parts to be connected, e.g., for connection thereof. The device comprises an application mechanism for applying an application agent to the joint locations, at least one measurement mechanism for measuring the surfaces of the joint locations, and a movement mechanism for moving the measurement mechanism along the joint locations. At least one application parameter is determined depending on the surfaces measured, whereby a surface-dependent application process can be achieved.

### CROSS-REFERENCE TO RELATED APPLICATIONS

This application is a National Phase of, and claims priority to, International Application No. PCT/EP2013/001324, filed on May 3, 2013, which claims priority to German Application No. DE 10 2012 008 965.1 filed on May 3, 2012, and German Application No. DE 10 2012 021 658.0 filed on Nov. 5, 2012, each of which applications are hereby incorporated by reference in their entireties.

### BACKGROUND

In the production of rotor blades for wind power plants by means of manual adhesive application, rotor blade half-shells are positioned in a defined position with respect to each other and are bonded together after application of adhesive. Because of tolerances in the rotor blade half-shells, a joint gap often has relatively large tolerances. These tolerances are usually determined, e.g. by kneading mass, and the adhesive quantity increased manually if an under metering is may exist. With automated adhesive application, the adhesive is applied by robots along a predefined, taught track. Normally a fixed application quantity is assigned to each point of this track.

A disadvantage with conventional rotor blade production methods is that they often lead to increased material consumption. Usually because of existing component tolerances, the adhesive must be oversupplied in order to achieve a complete joint filling. Furthermore the rotor blades produced according to conventional methods often warrants improvement and/or conventional rotor blade production methods are associated with additional reworking.

Normally two rotor blade half-shells are bonded together, wherein at least one web is inserted between the two rotor blade half-shells and bonded to the inner walls of the two rotor blade half-shells. The problem arises here that production of the rotor blade half-shells and the webs is associated with substantial component tolerances, so that the adhesive gaps between the two rotor blade half-shells and between the rotor blade half-shells and the webs are also correspondingly associated with tolerances, which in production leads to fluctuating gap sizes. This in turn is problematic because enough adhesive must be applied to ensure a durable adhesive seam even with a maximum gap size. For a minimum gap size of the adhesive gap therefore, surplus adhesive is usually applied which in the extreme case can lead to detachment of adhesive residue, which then in operation of the wind power plant can fly around inside the rotor blade and cause damage. Furthermore it must be recalled that the mechanical load-bearing capacity of an adhesive seam depends on the thickness of the adhesive seam and/or the gap size. The bonding partners for a gap size of zero are not bonded together at all, since then no adhesive can be applied to the adhesive surfaces. In contrast with an extremely large gap size, as the gap size increases, the mechanical load-bearing capacity of the adhesive joint is reduced since the adhesive itself only has a relatively low mechanical strength. It would be desirable to create an adhesive seam with a specific optimum thickness which is greater than zero and allows a maximum mechanical load-bearing capacity of the adhesive joint.

### SUMMARY

Disclosed herein is a device, in particular for measuring surfaces of joint locations of at least two joint parts to be connected, e.g., for connection thereof. The joint parts to be connected are, e.g., half-shells for production of a rotor blade for a wind power plant and/or reinforcing webs for the same. The device is therefore in particular a device for production of rotor blades for wind power plants. A corresponding method and a rotor blade produced using the method is also disclosed.

A device may be created in particular for measuring surfaces of joint locations of at least two joint parts to be connected together and/or for connection thereof. The device can comprise an application mechanism for application of an application agent, e.g., an adhesive material (e.g. glue) and/or a sealing material, to the joint locations. The device can comprise at least one measurement means for measuring the surfaces of the joint locations, in particular the surface contours (e.g. surface topology, surface geometry etc.) and e.g. a movement means for moving the measurement means in particular along the joint location. The device is in particular configured so that at least one application parameter, e.g., influencing the application process, can be determined depending on the surface measured, whereby a surface-dependent, in particular surface tolerance-dependent, application process can be achieved.

With the device, it is possible, for example, to determine discrepancies between actual joint location contours and desired joint location contours, and to adapt the application process accordingly. As a result, e.g., the application agent can be metered so that neither too much nor too little application agent is applied. Also, if necessary, for example, the course of the application agent bead to be applied can be varied depending on the surfaces measured.

It is possible that the at least one application parameter comprises the quantity of application agent to be applied. The quantity can, e.g., comprise a substantially constant outflow rate and/or a varying outflow rate.

For example, the application parameter can be determined depending on desired joint location contours which for example can be stored in a memory means.

In particular, determination of the application parameter can be dependent on the discrepancy between the surface contours measured, which can represent actual joint location contours, and desired joint location contours.

In particular, the quantity of the application agent to be applied, or in general the at least one application parameter, can be varied depending on a correction value determined from the discrepancy.

The at least one application parameter can, alternatively or additionally, comprise the movement dynamic (e.g. speed) and/or the movement track to be performed by the movement mechanism and/or the application mechanism. Because the movement mechanism e.g., serves to move the application mechanism, the movement dynamic and/or the movement track to be performed by the movement mechanism comprises in particular, the movement dynamic and/or the movement track to be performed by the application mechanism.

Also the at least one application parameter may, for example, comprise the track course of the application agent bead (e.g. adhesive or sealant bead) to be applied.

In particular it is possible that a variable outflow quantity (e.g. outflow rate) of application agent can be produced which is adapted to the measured surfaces, and/or a variable movement dynamic (e.g. speed) and/or movement track of the movement mechanism, in particular of the application mechanism, can be produced which is adapted to the measured surfaces.

The at least one application parameter is, e.g., defined such that filling of a joint is guaranteed but over-filling of the joint is at least reduced, or generally an over- or under metering of the application agent is at least reduced.

It is possible that the measurement mechanism additionally serves for track guidance and thus expediently a measurement mechanism-guided, in particular sensor-guided, application of the application agent can be achieved. The measurement mechanism can comprise several measurement mechanisms provided for different purposes. It is however possible that one and the same measurement mechanism is used both to measure and to achieve a measurement mechanism-guided track guidance. It should be mentioned that a track guidance system can also be integrated, e.g., in the measurement mechanism, in particular a sensor.

The at least one measurement mechanism can e.g. comprise at least one sensor, in particular a 2D or 3D sensor, at least one distance sensor, at least one optical sensor and/or at least one camera system.

The movement mechanism also, e.g., serves to move, in particular to guide the application mechanism. This allows, e.g., that the application mechanism can be moved e.g., together with the measurement mechanism. In particular the measurement mechanism and the application mechanism can be arranged adjacent to each other. Alternatively or additionally, the measurement mechanism is, e.g., oriented forward relative to the movement direction. For example, the application mechanism may be arranged behind the measurement mechanism relative to the movement direction.

The movement mechanism can comprise, e.g., a robot, in particular a multi-axis robot, on which the measurement mechanism and/or the application mechanism is mounted. Alternatively or additionally, the movement mechanism can comprise a travelling portal construction that, e.g., comprises at least two side parts (e.g., two supports, one support and one wall, etc.) and a carrier connecting the side parts, wherein the multi-axis robot can travel along the carrier and/or extends down from the carrier. The travelling portal construction also comprises, e.g., a unilateral or bilateral wall- and/or floor-guided portal construction.

It is possible that the device comprises, e.g., a dynamic mixing mechanism which is configured to mix multi-component adhesive material. The mixing mechanism is, e.g., arranged directly before or in the application mechanism.

It is possible that a material supply containing the application agent is mounted on the travelling portal construction and, e.g., moved together with the portal construction.

Also the device can comprise a metering unit for metering the application agent to be applied. The metering unit can travel together with the multi-axis robot, e.g., along said carrier. The afore-mentioned quantity is therefore, e.g., a metered quantity.

The device can comprise a calculation and/or control unit programmed to carry out one or more determinations and/or to control the device components, wherein a regulation is included. The one or more determinations can, e.g., be carried out in real time.

The device can also comprise a handling apparatus which is configured to bring together the joint parts to be connected for bonding, after application of the application agent.

The joint parts to be connected are, e.g., half-shells for a rotor blade for a wind power plant and/or reinforcing webs for the same. The device is thus in particular a device for production of rotor blades for wind power plants or at least part thereof.

The at least one application parameter can in particular relate to the application agent (e.g., quantity, outflow rate, application bead course etc.), the application mechanism and/or the movement mechanism (e.g., movement dynamic, speed, movement track, application bead course, etc.). In the context of the invention, the application parameter can relate to any component associated with the device, which need not necessarily be connected to the actual application of the application agent. In the context of the invention, the application parameter can, e.g., comprise processes before, during and/or after application of the application agent.

It should be mentioned that, in particular, a variable outflow rate of the application agent is possible with substantially constant speed of the movement mechanism (in particular the tool centre point (TCP)) and/or a substantially constant outflow rate with variable speed of the movement mechanism.

A method is disclosed, in particular for measuring joint locations of at least two joint parts to be connected and/or for connection thereof, which can, e.g., be executed by mechanism of a device as described herein. In the method, e.g., an application mechanism is moved along the joint locations and an application agent is applied to the joint locations, a measurement mechanism is expediently moved along the joint locations, e.g., surfaces of the joint locations are measured, and at least one application parameter, e.g., influencing the application process, is determined depending on the measured surfaces, whereby expediently a surface-dependent, in particular surface tolerance-dependent, application process can be achieved.

The method is intended in particular as a production method for a rotor blade for a wind power plant or at least part thereof.

Disclosed herein are various further variants to solve the problems described above on bonding of rotor blade half-shells for a wind power plant.

In a variant, first at least one web is bonded to an inner wall of a first rotor blade half-shell, wherein a first adhesive material is used with a first pot life. The pot life here is defined as the duration of the processing ability of the respective adhesive. In an exemplary embodiment, normally two such webs are bonded to the inner wall of the first rotor blade half-shell, but in principle it is also possible for a different number of webs to be inserted between the two rotor blade half-shells.

Then a second rotor blade half-shell is bonded to the first rotor blade half-shell and to the web or webs, wherein a second adhesive material is used with a second pot life.

In this variant, the first adhesive has a shorter pot life than the second adhesive. This is advantageous because on bonding of the web to the first rotor blade half-shell, only a single adhesive seam need be applied for each web, which requires relatively little time so that a fast-curing adhesive can be used. This is also advantageous because the web must usually be aligned precisely during curing, so that rapid curing is desirable. On bonding of the second rotor blade half-shell however, two adhesive seams must be applied between the two rotor blade half-shells and additionally a further adhesive seam for each web, which requires more time because of the larger number of adhesive seams, so that a longer pot life is desirable.

Another variant, however, takes account of the fact that the rotor blade half-shells are normally produced in a mould, so that the half-shell outer dimensions of the individual rotor blade half-shells are predefined by the inner dimension of the mould used, while the half-shell inner dimensions of the individual rotor blade half-shells vary depending on production. In this variant, therefore, for the individual rotor blade half-shells, a half-shell inner dimension and a half-shell outer dimension is measured respectively, from which the wall thickness of the rotor blade half-shells and/or an adhesive gap size of the adhesive gap between the rotor blade half-shells can be calculated. When the adhesive is applied between the two rotor blade shells, an application parameter (e.g. adhesive quantity) is then set depending on the so calculated wall thickness and/or the so calculated adhesive gap size. Here it is sufficient if the half-shell outer dimension is measured once using the predefined production mould, while the half-shell inner dimension is measured, e.g., individually for each rotor blade half-shell.

It has already been mentioned above that, e.g., at least one web is inserted between the two rotor blade half-shells, which is bonded to the inner walls of the two rotor blade half-shells. For example, the adhesive seam for bonding the web in one of the rotor blade half-shells can be applied by a robot at a structurally predefined position. The adhesive seams are applied as flat as possible in order to allow as great a tolerance reserve as possible for the adhesive seams on the opposite end of the web.

Furthermore, as already mentioned above, on bonding to the inner wall of a rotor blade shell, the webs must be aligned spatially precisely until the adhesive has cured. To facilitate a precise spatial orientation of the individual webs, in one variant it is proposed that an optical alignment aid is projected onto the web, using which an operator can align the web manually. For example by mechanism of a laser, a laser marking can be projected onto the free end of the web.

It has already been pointed out above that the production of the rotor blade half-shells is associated with substantial component tolerances, which leads to corresponding tolerances of the adhesive gap size, in particular between the free ends of the webs and the rotor blade half-shells to be bonded thereto. In a further variant, it is therefore proposed that a distance dimension is measured between a reference plane and the free end of the respective web. Then depending on this, a gap size of the adhesive gap is calculated between the free end of the web and the rotor blade half-shell to be bonded thereto. When the adhesive is applied to the free ends of the webs and/or to the associated adhesive surface on the inner wall of the other rotor blade half-shell, an application parameter (e.g. adhesive quantity) is then adapted according to the calculated gap size.

Also disclosed is a rotor blade for a wind power plant which was produced using the method as described herein.

### BRIEF DESCRIPTION OF THE DRAWINGS

The features and embodiments described above can be combined in any fashion. Other advantageous developments are disclosed in the dependent claims and/or arise from the description below of exemplary embodiments in conjunction with the enclosed figures.

FIG. 1A shows a perspective view of two joint parts to be connected and a device according to an embodiment;

FIG. 1B shows an enlarged portion of the device from FIG. 1A;

FIG. 2 shows a schematic principle view of an actual joint location contour, a desired joint location contour and a device according to an embodiment;

FIG. 3 shows a perspective view of two joint parts to be connected and a part of a device according to an embodiment;

FIG. 4 shows a schematic perspective view of two rotor blade halves and two reinforcing webs for these according to an embodiment;

FIG. 5 shows a flow diagram of a method according to an embodiment;

FIGS. 6A-6E various production stages on bonding of two rotor blade half-shells with two webs into a rotor blade for a wind power plant;

FIGS. 7A and 7B cross sections through two rotor blade half-shells which must be bonded together into a rotor, wherein a rotor blade inner dimension and a rotor blade outer dimension are marked respectively;

FIG. 8 a cross section view through a rotor blade half-shell with two webs bonded in, wherein the adhesive gap size between the free ends of the webs and the rotor blade half-shell to be bonded thereto is measured.

The embodiments described with reference to the figures partially correspond, wherein similar or identical parts carry the same reference signs, and for explanation thereof reference is made to the description of other embodiments or figures in order to avoid repetition.

### DETAILED DESCRIPTION OF EXEMPLARY EMBODIMENTS

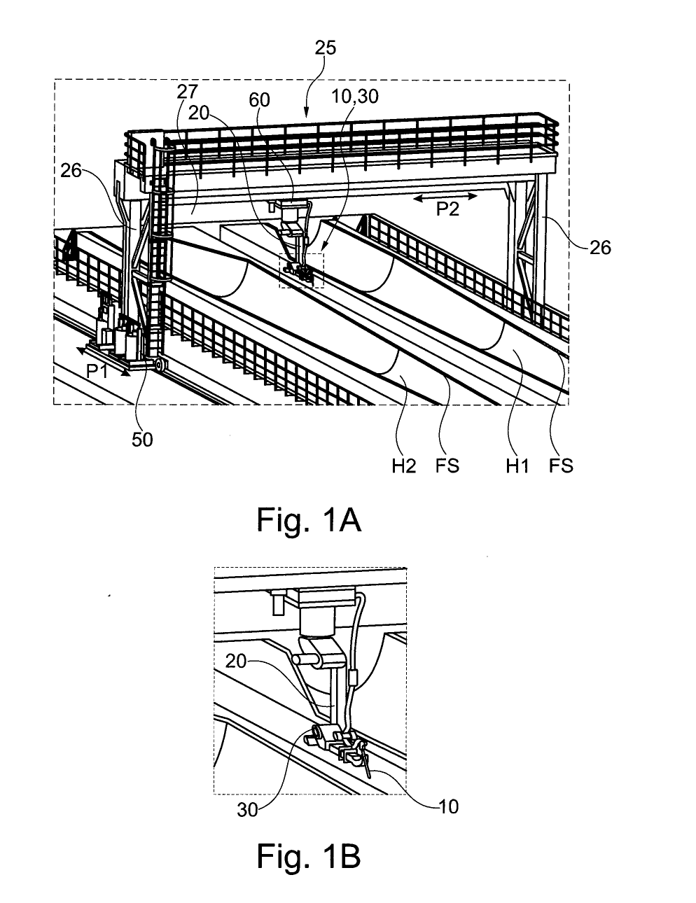

FIG. 1A shows a device for measuring surfaces of joint locations FS of two joint parts H1 and H2 to be connected. The joint parts H1 and H2 are rotor blade half-shells for production of a rotor blade for a wind power plant. FIG. 1B shows an enlarged portion of the device from FIG. 1A.

The device comprises a measurement mechanism 10 for measuring the surfaces of the joint locations FS, in particular the surface contours (e.g., surface topology, surface geometry, etc.). The device furthermore comprises an application mechanism 30 for application of an application agent, in particular an adhesive or sealant material, to the joint locations FS. The device furthermore comprises a movement mechanism 20, 25 for moving the measurement mechanism 10 and the application mechanism 30 along the joint locations FS. The measurement mechanism 10 is arranged adjacent to the application mechanism 30 and oriented forward relative to the movement direction.

The movement mechanism comprises a travelable portal construction 25 which comprises two side parts 26 and a carrier 27 connecting the side parts 26. The movement mechanism also comprises a multi-axis robot 20 to guide the measurement mechanism 10 and the application mechanism 30. The multi-axis robot 20 can travel along the carrier 27 along arrow P2 and extends down from the carrier 27. The device also comprises a material supply 50 which is mounted on the travelable portal construction 25 and moved with the portal construction 25.

The device furthermore comprises a metering unit 60 for metering the application agent to be applied. The metering unit 60 can e.g., travel together with the multi-axis robot 20 along the carrier 27.

The device is configured such that at least one application parameter is determined depending on the measured surfaces of the joint locations FS and thereby a surface-dependent application process can be achieved.

Thus it is possible that the quantity of application agent to be applied is determined depending on the measured surface, and the application process is adapted accordingly.

Such determination is carried out, e.g., depending on desired joint location contours and in particular depending on a discrepancy between measured surface contours, which therefore describe actual joint location contours, and desired joint location contours. The quantity of application agent to be applied can be varied depending on a correction value determined from the discrepancy.

It is also possible that the movement dynamic and/or movement track of the application mechanism 30 to be performed is determined depending on the measured surfaces of the joint locations FS, and the application process is adapted accordingly. This, e.g., also allows that the course of the application agent bead is executed depending on the measured surfaces of the joint locations FS.

Thus a variable application agent outflow quantity can be produced which is adapted to the measured surfaces of the joint locations FS, and, alternatively or additionally, a variable movement dynamic/movement track of the movement mechanism 20, 25, and thus of the application mechanism 30, can be produced, which movement is adapted to the measured surfaces of the joint locations FS.

The quantity of application agent to be applied and the movement dynamic of the movement mechanism 20, 25 to be performed are defined so that a filling of an adhesive or sealant joint is guaranteed, but an over-filling of the adhesive or sealant joint is at least reduced.

The measurement mechanism 10 can also serve for track guidance, so that a measurement mechanism-guided, in particular sensor-guided application process can be achieved. In the context of the invention, the measurement mechanism 10 can be formed from several measurement mechanisms.

The measurement mechanism 10 can e.g. comprise one or more measurement devices such as one or more suitable sensors (e.g. 2D or 3D sensors, distance sensors, optical sensors etc.) or one or more camera systems.

The device can also comprise a mixing mechanism (not shown) in order to mix multi-component adhesive material. The mixing mechanism is e.g., arranged directly before or even in the application mechanism 30, and in particular serves for mixing so called 2K adhesives.

The application agent can be a conventional adhesive or a conventional sealant material which are used in the production of rotor blades for wind power plants.

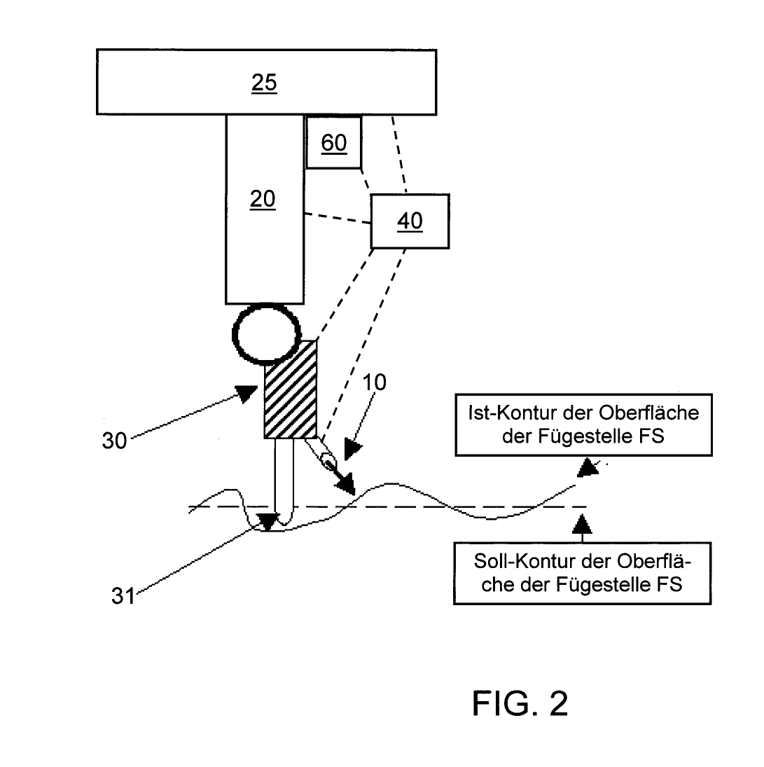

FIG. 2 shows a schematic principle view of a device according to an embodiment. FIG. 2 shows highly schematically a portal construction 25, a multi-axis robot 20 mounted travelable on the portal construction 25, and an application mechanism 30 guided by the multi-axis robot 20, wherein a measurement mechanism 10 is provided on the application mechanism 30. An application nozzle 31 is also shown which is assigned to the application mechanism 30. Furthermore, a metering mechanism 60 is depicted schematically. The metering mechanism 30 serves for metering the application agent to be applied, and can travel together with the multi-axis robot 20.

Also a desired contour of the surface of a joint location FS and an actual contour of the surface of the joint location FS can be seen. It will be understood that the desired contour corresponds to an idealized surface contour which rarely occurs in practice, and an application of the application agent with reference purely to the desired contour would lead to an over metering and/or under metering of the application agent.

Because application parameters are determined depending on a surface measured and hence actually present, the application process is not based only on theoretical desired assumptions but on actual data, whereby, e.g. an over metering and/or under metering can at least be reduced.

FIG. 2 also shows a calculation/control unit 40 which is configured to carry out the determinations of the application parameter and/or to control the device accordingly, wherein a regulation can be also included in embodiments disclosed herein. The determinations carried out by the control/calculation unit 40 can, e.g., take place in real time. The calculation/control unit 40 can be operatively connected directly or indirectly to the measurement mechanism 10, the movement mechanism 20, 25, the application mechanism 30, the material supply 50 and/or the metering unit 60.

The device can also comprise a handling apparatus which is configured to bring together for bonding, after application of the adhesive and/or sealant material to the joint locations FS, the half-shells H1 and H2 to be connected. The handling apparatus can be a conventional handling apparatus for bringing together two half-shells for production of a rotor blade for a wind power plant.

In an embodiment, the device is configured to perform the following process steps:
1. detection of the surfaces of the joint locations FS,
2. calculation of the necessary application agent quantity, wherein the measured surface contour is compared with the desired surface contour, and the application agent quantity to be applied and/or a correction value is calculated from the difference,
3. adaptation of the necessary application agent metering quantity depending on the correction value, and
4. possibly, sensor-guided application of the application agent

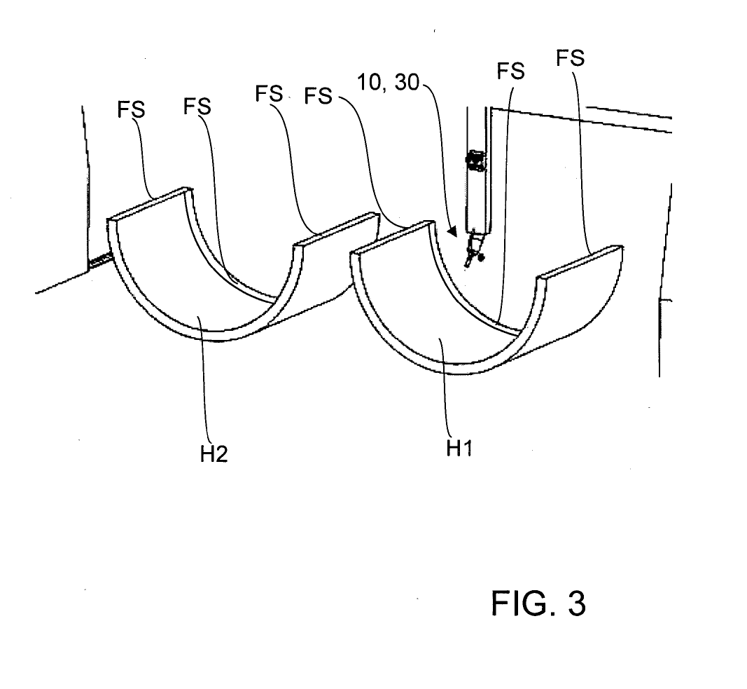

FIG. 3 shows a perspective view of two joint parts H1 and H2 to be connected and part of a device according to an embodiment. FIG. 3 again shows a measurement mechanism 10 and an application mechanism 30 which are guided by a movement mechanism shown only in part. The joint locations FS of joint part H1 running straight in FIG. 3 serve for bonding to the joint locations FS of joint part H2 running straight in FIG. 3, while the joint locations FS running curving in FIG. 3 serve for bonding to a reinforcing web (not shown in FIG. 3).

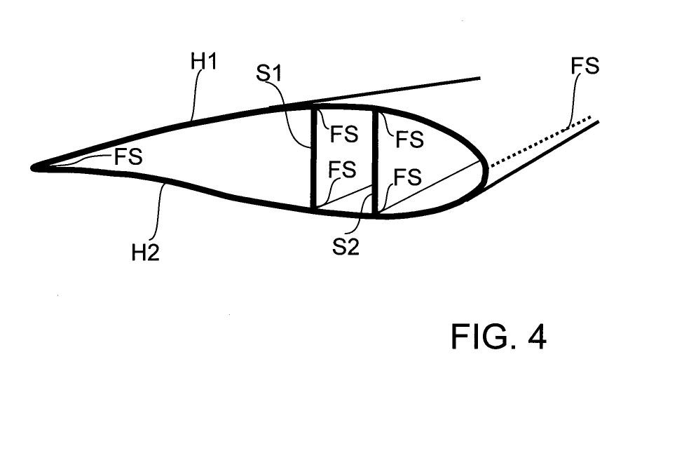

FIG. 4 shows a schematic view of a rotor blade for a wind power plant according to an embodiment. The rotor blade is formed by two half-shells H1 and H2 and two reinforcing webs S1 and S2 reinforcing the half-shells H1 and H2. Reference signs FS indicate joint locations between the connected half-shells H1 and H2 (in FIG. 4, the left and right joint locations FS), and joint locations between the reinforcing webs S1 and S2 and the half-shells H1 and H2 (in FIG. 4, the middle joint locations FS).

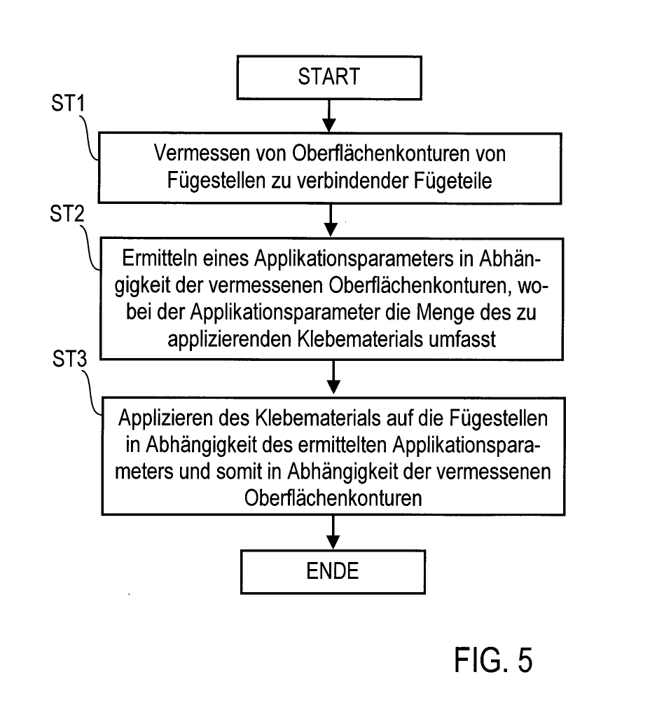

FIG. 5 shows a flow diagram of a method according to an embodiment, in particular for measuring surfaces of joint locations FS of at least two joint parts H1, H2, S1 and S2 to be connected, and e.g., for connection thereof. The method can be used, e.g., in a production process for a rotor blade for a wind power plant and in particular is carried out with a device as described above.

In a step ST1, first surface contours of joint locations FS of joint parts H1, H2, S1 and S2 to be connected are measured.

In a step ST2, then at least one application parameter is determined depending on the measured surface contours, wherein the application parameter e.g., comprises the quantity of application agent to be applied, but can also comprise, e.g., the movement speed and/or movement track of the application mechanism 30 and/or the movement mechanism 20, 25 guiding the application mechanism 30.

In a step ST3, the application agent is applied to the joint locations FS depending on the determined application parameter, and hence depending on the measured surface contours. In addition or alternatively, the movement mechanism 20, 25 guiding the application mechanism 30 can be controlled or regulated depending on the measured surface contours, in particular in relation to its speed and/the movement track to be performed.

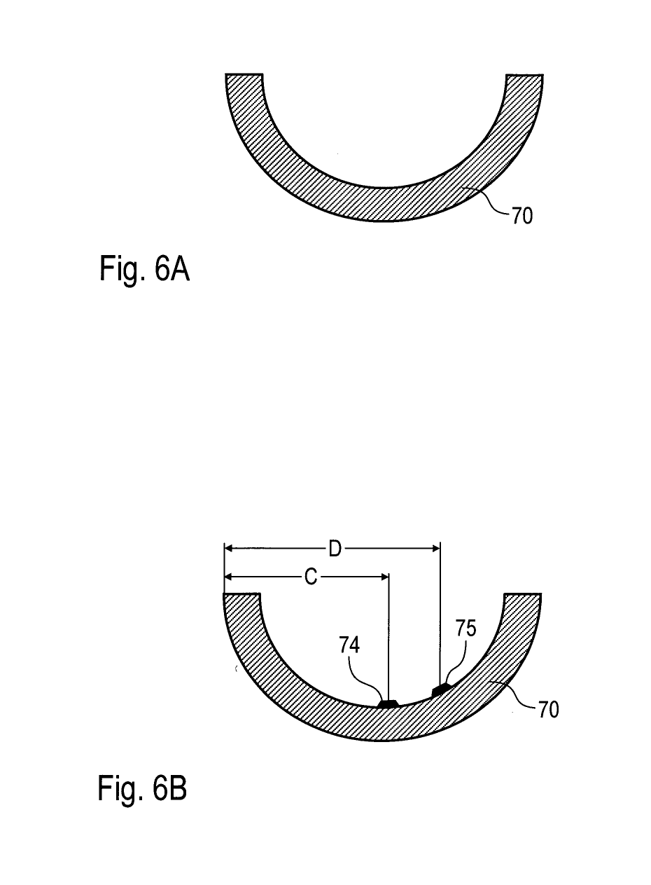

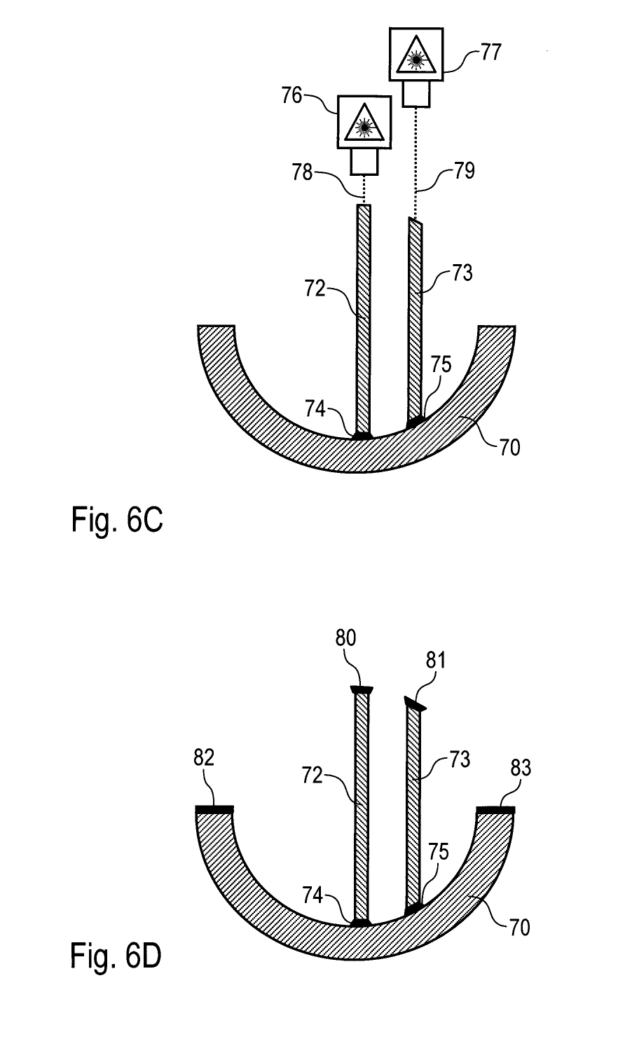

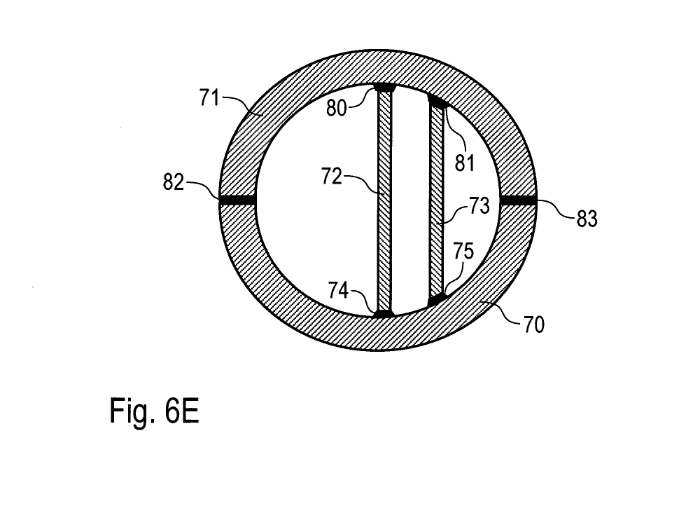

Now the variant depicted in FIGS. 6A to 6E is described below.

Here, two rotor blade half-shells 70, 71, depicted only schematically, are bonded together, wherein two webs 72, 73 are inserted between the two rotor blade half-shells 70, 71 to increase the stiffness of the resulting rotor blade, which is important for use in a wind power plant.

In a first step, according to FIG. 6A first the rotor blade half-shell 70 is provided.

In a second step, according to FIG. 6B, on the inner wall of the rotor blade half-shell 70, two adhesive beads 74, 75 are applied which run in the longitudinal direction of the rotor blade half-shell 70. The adhesive bead 74 is here applied at a distance C from the side edge of the rotor blade half-shell 70, whereas the adhesive bead 75 is applied at a distance D from the side edge of the rotor blade half-shell 70. Distances C, D are structurally predefined, wherein the adhesive beads 74, 75 are applied controlled by a robot, which ensures that distances C, D are achieved with low tolerances.

In a next step, according to FIG. 6C, the webs 72, 73 are placed on the adhesive beads 74, 75 in order to bond the webs 72, 73 to the rotor blade half-shell 70. The webs 72, 73 must be oriented spatially precisely until the adhesive of the adhesive beads 74, 75 has cured. The webs 72, 73 are aligned manually by an operator. To facilitate the manual alignment of webs 72, 73, two lasers 76, 77 are provided which each project a laser marking 78, 79 onto the free ends of the webs 72, 73. The operator can then align the webs 72, 73 according to the laser markings 78, 79, ensuring that the webs 72, 73 are aligned according to the predefined technical specification.

In a further step, according to FIG. 6D, further adhesive beads 80, 81, 82, 83 are applied on the free ends of the web 72 and on the adhesive surfaces of the rotor blade half-shell 70.

In a next step, according to FIG. 6E, the other rotor blade half-shell 71 is put on and bonded to the rotor blade half-shell 70 and webs 72, 73.

The adhesive beads 74, 75 here consist of a relatively rapidly curing adhesive, whereas the adhesive beads 80-83 consist of a slower curing adhesive. This is useful because the two adhesive beads 74, 75 can be applied relatively quickly, whereas application of the adhesive beads 80-83 requires more time because of the larger number of adhesive beads 80-83.

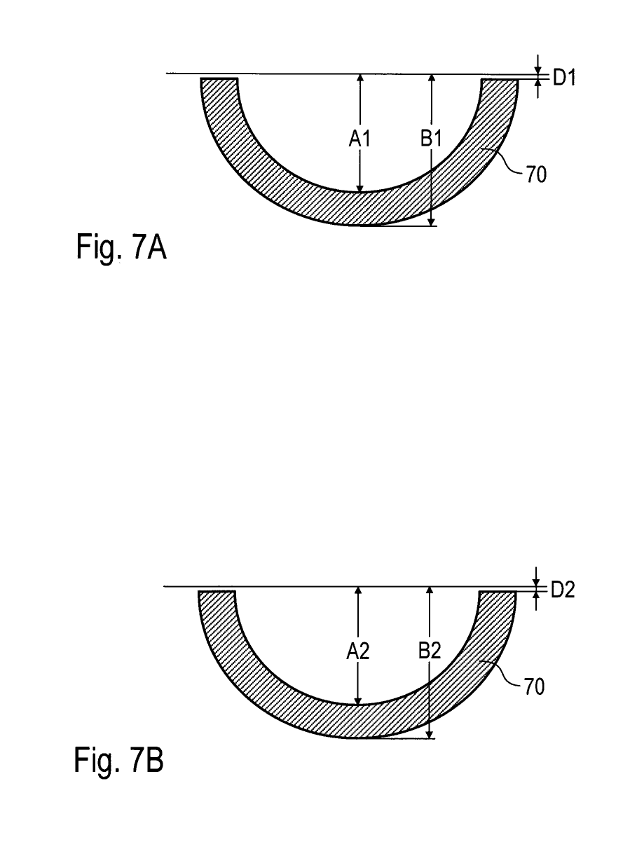

Usually the rotor blade half-shells 70, 71 are produced in a mould, so that the rotor blade half-shells 70, 71 have a constant rotor blade outer dimension B1, B2 which is predefined by the inner dimension of the mould used, as is clear from FIGS. 7A and 7B. In the variant according to FIGS. 7A and 7B, therefore usually the rotor blade outer dimension B1 and/or B2 is measured once on the basis of the mould used.

In production of the individual rotor blade half-shells 70, 71 however, the respective rotor blade inner dimension A1 and/or A2 varies from component to component. Therefore the rotor blade inner dimension A1, A2 is, e.g., measured individually for each component.

Then a thickness D1 of the resulting adhesive gap between the two rotor blade half-shells 70, 71 can be calculated from the measured values for the rotor blade inner dimension A1, A2 and the rotor blade outer dimension B 1, B2. In the application of the adhesive beads 81, 82, then an application parameter (e.g. adhesive quantity) is adapted accordingly.

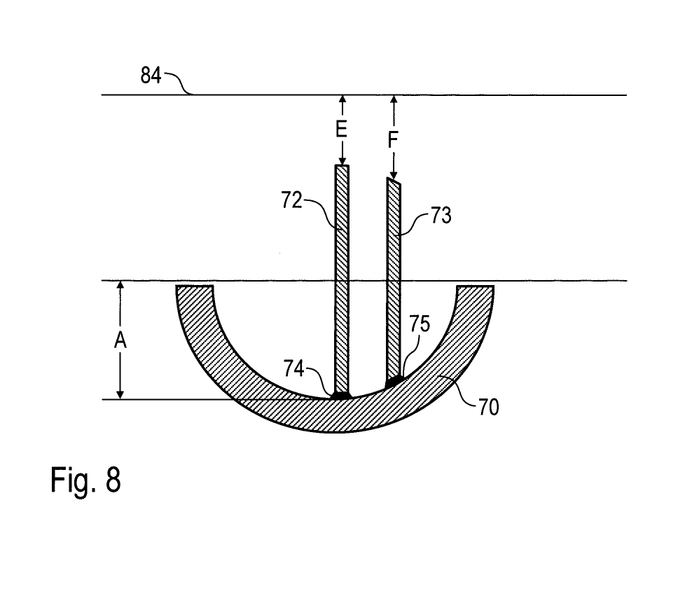

Finally FIG. 8 shows a further variant which partly corresponds to the variants described above, so that to avoid repetition, reference is made to the description above, wherein for corresponding details the same reference signs are used.

A special feature here is that after bonding of the webs 72, 73 to the inner wall of the rotor blade half-shell 70, distance E and/or F between the free ends of the webs 72, 73 and a reference plane 84 is measured. Distance values E, F fluctuate depending on the also fluctuating wall thickness of the rotor blade half-shell 70. The distance values E, F can then be taken into account on application of the adhesive beads 80, 81 (see FIG. 6D) to the free ends of webs 72, 73, in order to be able to adapt the adhesive beads 80, 81 accordingly.

The invention is not restricted to the preferred embodiments described above. Rather a plurality of variants and derivations is possible which also make use of the inventive concept and therefore falls within the scope of protection. In addition, the invention claims protection for the subject-matter and the features of the subclaims, independently of the claims and features to which they refer.

1-26. (canceled)

27. A device for connecting joint locations of at least two joint parts to be connected, comprising:
an application mechanism situated to apply an application agent to at least one of the joint locations; and
at least one measurement device that is arranged to measure at least one surface of the joint locations, the at least one measurement device being movable by a movement mechanism along at least one of the joint locations;
wherein the device is programmed to determine at least one application parameter depending on the measurement of the at least one surface to achieve a surface-dependent application process.

28. The device according to claim 27, wherein the at least one application parameter comprises a quantity of application agent to be applied.

29. The device according to claim 27, wherein the determination of the at least one application parameter is carried out based on at least one desired joint location contour.

30. The device according to claim 27, wherein the determination of the at least one application parameter is carried out based on a discrepancy between at least one measured surface contour and at least one desired joint location contour.

31. The device according to claim 30, wherein a quantity of the application agent to be applied is varied depending on a correction value determined from the discrepancy.

32. The device according to claim 27, wherein the at least one application parameter comprises at least one of a planned movement track of the application mechanism and a track course of an application agent bead to be applied.

33. The device according to claim 27, wherein at least one of the following is producible:
a variable outflow quantity of the application agent which is adapted to the at least one measured surface, and
a variable movement dynamic/movement track of the application device (which is adapted to the at least one measured surface.

34. The device according to claim 27, wherein the at least one application parameter is established such that filling of a joint is guaranteed but an over-filling of the joint is at least reduced.

35. The device according to claim 27, wherein the measurement device comprises at least one of:
at least one 2D sensor,
at least one 3D sensor,
at least one distance sensor,
at least one optical sensor, and
at least one camera system.

36. The device according to claim 27, wherein the measurement device further serves for track guidance.

37. The device according to claim 27, wherein
the application device and the measurement device are moveable by the movement mechanism along at least one of the joint locations, and
the measurement device is arranged at the application device and is oriented forward relative to a movement direction.

38. The device according to claim 27, wherein the movement device comprises:
a multi-axis robot at which the measurement device and the application device are mounted, and
a travelable portal construction which comprises at least two side parts and a carrier connecting the side parts, wherein the multi-axis robot is moveable along the carrier and extends down from the carrier.

39. The device according to claim 27, wherein a dynamic mixing mechanism is provided to mix multi-component adhesive material, and is arranged one of directly before and in the application device.

40. The device according to claim 38, wherein a material supply is mounted on the travelable portal construction and is moveable together with the portal construction.

41. The device according to claim 27, further comprising an application agent metering unit that is moveable together with the multi-axis robot along the carrier.

42. The device according to claim 27, wherein a calculation/control unit is configured to carry out the determination of the at least one parameter in real time.

43. The device according to claim 27, further comprising a handling apparatus that is configured to bring together for bonding, after application of the application agent, the joint parts to be connected.

44. The device according to claim 27, wherein the joint parts to be connected are at least one of half-shells for production of a rotor blade for a wind power plant and reinforcing webs for the rotor blade.

45. The device according to claim 27, wherein the application agent is at least one of sealant material and adhesive material.

46. The device according to claim 27, wherein the measurement device is arranged to measure at least one surface contour of the joint locations.

47. A method for connecting joint locations of at least two joint parts to be connected, the method comprising:
moving an application device and at least one measurement device along at least one of the joint locations, wherein at least one surface of the joint locations is measured;
determining at least one application parameter depending on the at least one surface measured; and
applying an application agent to at least one of the joint locations, thereby achieving a surface-dependent application process.

48. A method according to claim 47, wherein:
bonding at least one web to an inner wall of a first rotor blade half-shell, wherein a first adhesive material with a first pot life is used; and
bonding a second rotor blade half-shell to the first rotor blade half-shell and to the web, wherein a second adhesive material with a second pot life is used;
wherein the first pot life is shorter than the second pot life.

49. The method of claim 47, further comprising:
measuring a half-shell inner dimension for two rotor blade half-shells which are connected together;
measuring a half-shell outer dimension for the two rotor blade half-shells which are connected together;
calculating at least one of the wall thickness of the two rotor blade half-shells and an adhesive gap size of the adhesive gap between the two rotor blade half-shells, from the measured half-shell inner dimension and the measured half-shell outer dimension;
applying the adhesive material to bond the two rotor blade half-shells together, and
adjusting the application parameter during application of the adhesive material depending on at least one of the calculated wall thickness and the calculated adhesive gap size.

51. The method of claim 50, wherein:
the half-shell outer dimension is measured once on a predefined production mould for the rotor blade half-shells; and
the half-shell inner dimension is measured individually for each rotor blade half-shell.

52. The method of claim 47, further comprising:
establishing a desired position of at least one web in a rotor blade half-shell; and
applying the adhesive material by a robot at the established position to the inner wall of the rotor blade half-shell.

53. The method of claim 47, further comprising:
bonding at least one web to an inner wall of a rotor blade half-shell by an adhesive material;
aligning the web during a curing time of the adhesive material; and
projecting an optical alignment aid to the web to facilitate alignment of the web.

54. The method of claim 47, further comprising:
measuring a half-shell inner dimension for two rotor blade half-shells which are connected together;
bonding at least one web to an inner wall of one of the two rotor blade half-shells;
measuring a distance dimension between a reference plane and a free end of the web;
calculating a gap size of the adhesive gap between the free end of the web and the rotor blade half-shell to be bonded thereto based on the measured half-shell inner dimensions and the measured distance dimension; and
applying adhesive material to bond the free end of the web to the inner wall of the other rotor blade half-shell, wherein an application parameter depending on the calculated gap size of the adhesive gap is adapted.
